(19) United States
(12) Patent Application Publication
(10) Pub. No.: US 2012/0104715 A1
(43) Pub. Date: May 3, 2012

(54) MULTI-PERSON SKATEBOARD SYSTEM

(76) Inventors: Joseph Michael Alotta, Carson City, NV (US); Vincent Joseph Alotta, Carson City, NV (US)

(21) Appl. No.: 12/938,500

(22) Filed: Nov. 3, 2010

(51) Int. Cl. B62M 1/00

(52) U.S. Cl. 280/87.042

(57) ABSTRACT

An apparatus may comprise a plurality of boards for use by multiple humans. A first board of the plurality of boards and a second board of the plurality of boards may be connected by one or more cross members. Each cross member may have a first end and a second end. The first end may be connected to a first bracket on the first board and the second end may be connected to a second bracket on the second board.

### BACKGROUND OF THE INVENTION

The present invention generally relates to a multi-person skateboard system. More specifically, the invention relates to a skateboarding, longboarding, or luging device that is configured to connect two or more skateboards, longboards, or luge boards together to make these sports a multi-person team sport.

Skateboarding, longboarding, and luging have been a one man sport since the inception of these sports. This means one person rides on one skateboard, longboard, or luge board, and the riders compete against each other, making those sports lonely endeavors, with no tandem or team capabilities.

As can be seen, there is a need for a skateboarding system that can be used by one or more persons.

### SUMMARY OF THE INVENTION

In one aspect of the present invention, an apparatus comprises a first board, a second board, and one or more cross members, each cross member connecting the first board and the second board.

In another aspect of the present invention, an apparatus comprises a plurality of boards, a first board of the plurality of boards, a second board of the plurality of boards, and one or more cross members, each cross member having a first end and a second end, the first end connected to a first bracket on the first board and the second end connected to a second bracket on the second board.

These and other features, aspects and advantages of the present invention will become better understood with reference to the following drawings, description and claims.

### BRIEF DESCRIPTION OF THE DRAWINGS

FIG. 1 is a perspective view of the invention according to one embodiment;

FIG. 2 is a sectional view taken along line 2-2 of the embodiment of FIG. 1;

FIG. 3 is an exploded perspective view of the embodiment of FIG. 1;

FIG. 4 is an alternative embodiment of the invention illustrating an alternative connection of a bracket; and

FIG. 5 is an alternative embodiment of the invention illustrating the connection of an alternative bracket.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a multi-person skateboard system.

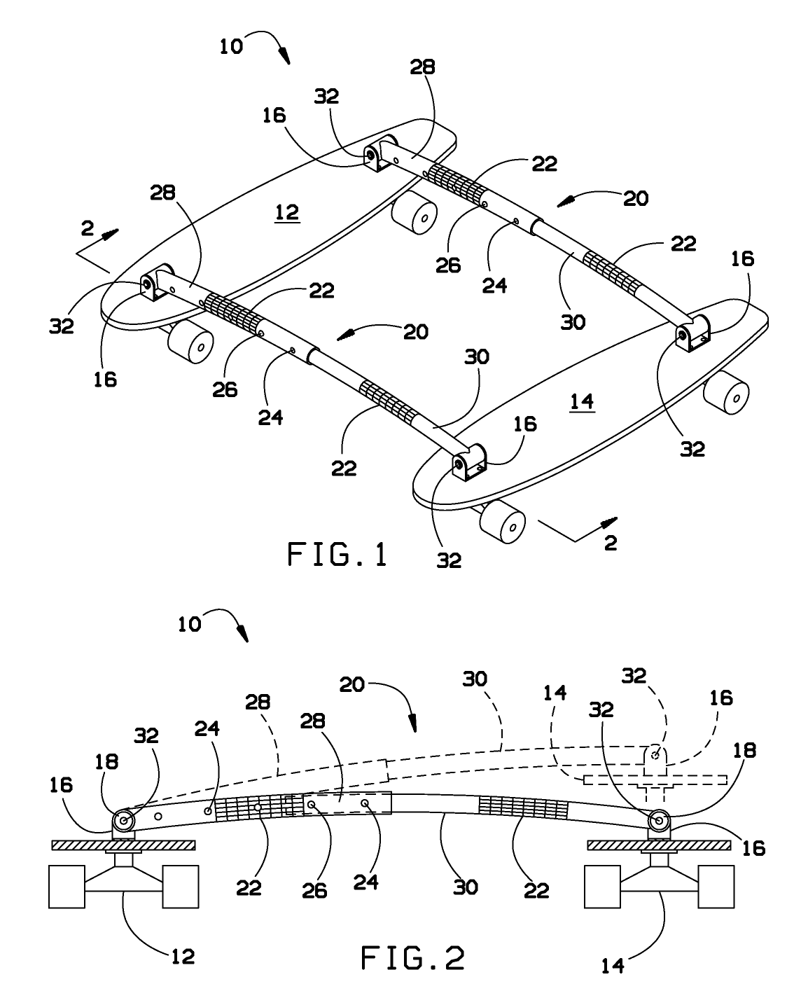

With reference to FIG. 1, a perspective view of a multi-person skateboard longboard or luge system 10, collectively called a multi-person board system 10, according to one embodiment is shown. According to one embodiment, the multi-person board system 10 may comprise a device configured to allow one or more human persons to ride at one time. The system 10 may have two or more complete skateboards, longboards, or luge boards, collectively called boards, 12 & 14. In one embodiment, each of these boards 12, 14 may comprise decks, trucks, wheels, bearings, hardware, and grip tape as with other boards.

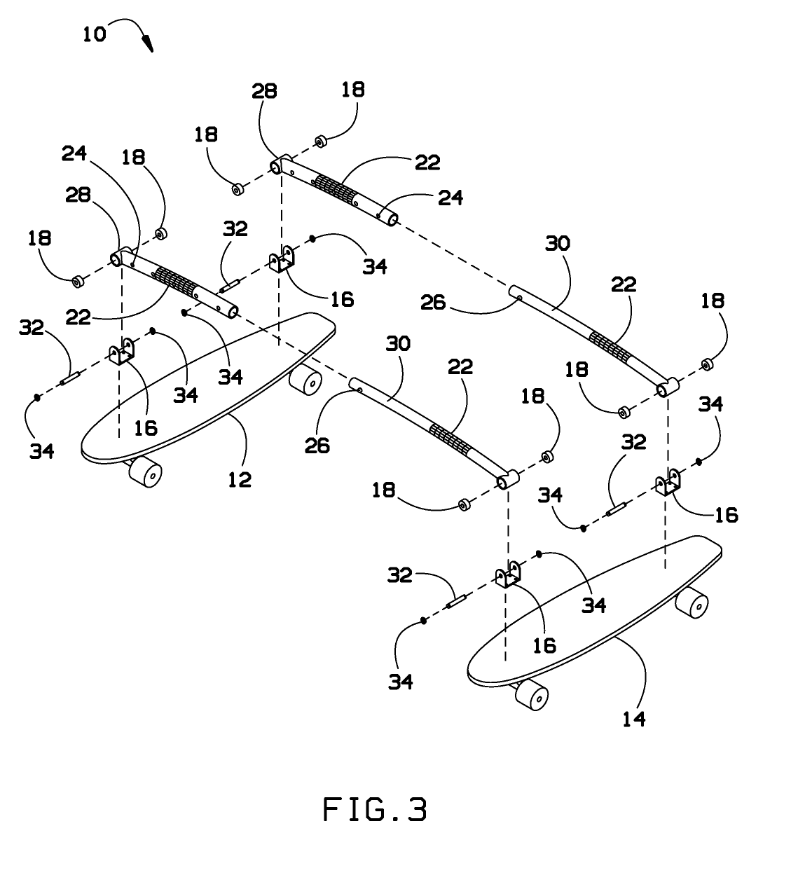

In one embodiment, the boards 12, 14 may be connected together by means of the following-described components. Brackets 16 may be configured to be attached to the board 12, 14. In the embodiment of FIG. 1, four brackets 16 are used. The brackets 16 may be comprised of a hard, strong material, including but not limited to wood, metal, and plastic, or the like. One or more cross members 20 may be configured to be attached to the brackets 16 by means of a shaft 32 inserted through the bracket 16, and through bearings 18 (see FIGS. 2-3) within ends of the brackets 16.

Each cross member 20 may extend from a bracket 16 on a first board 12 to a bracket 16 on another board 14. In some embodiments, cross members 20 may connect two or more boards 12, 14. In one embodiment, each cross member 20 may comprise a hard, strong material including but not limited to wood, metal, or plastic. The cross member 20 may be of varying shapes depending on the desired flexibility.

In one embodiment, the cross members may be adjustable to provide for different lengths. For example, in one embodiment, each cross member may be tubular, and may comprise an inner tube portion 30, and an outer tube portion 28, which can be slid with respect to each other to expand or contract the length of the cross member 20, or may be completely disengaged from each other. Each inner tube portion 30 may have one or more spring-loaded button locks 26 that can be pushed in while the inner tube portion 30 is inserted into the outer tube portion 28. When the desired cross member 20 length is achieved, the button lock 26 may then be allowed to be extended through one of one or more adjustment holes 24 cut in the outer tube portion 28.

Each of the inner tube portion 30 and outer tube portion 28 may have hand grips 22 for gripping by the users during use of the system 10.

With reference to FIG. 2, a sectional view taken along line 2-2 of the embodiment of FIG. 1 is shown. In FIG. 2, the bearings 18 within the ends of the cross members 20 permit the cross members 20 to pivot at the bracket. Further, the manner in which the bearings 18 allow the cross members 20 to turn through a range of angles with respect to each of the boards 12, 14 is shown in phantom.

With reference to FIG. 3, an exploded perspective view of the embodiment of FIG. 1 is shown. In particular, detail of how the bearings 18 fit into the ends of the cross members 20 are shown. Each end of the cross members 20 may fit into the bracket 16, and each shaft 32 may fit through a bracket 16 to attach an end of a cross member 20 to the boards 12, 14. Snap rings 34 may snap on ends of the shafts 32 to secure the shafts to the brackets 16, and therefore the brackets to the cross members 20.

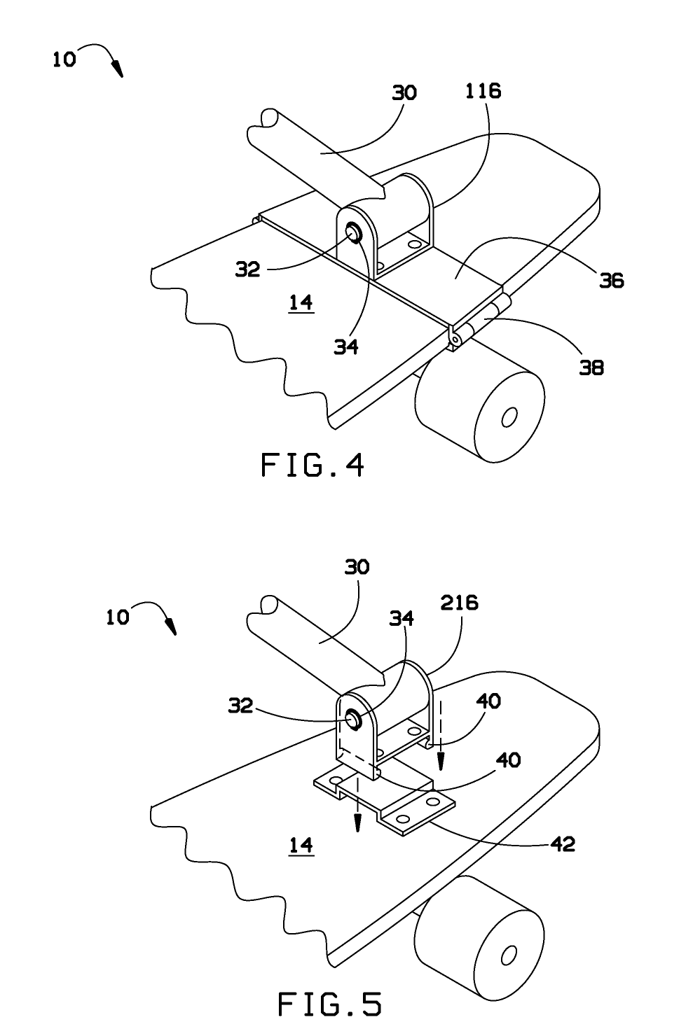

With reference to FIG. 4 an alternative embodiment of the system 10 illustrating an alternative connection of an alternative bracket 116 is shown. In the embodiment of FIG. 4, the bracket 16 may be attached to a clamp 36 that fits around the board 14. The claim may have a hinge 38, allowing the brackets 116 to be removable from the board 14 when attachment to another board (e.g., 12 in FIG. 1) is not desired.

With reference to FIG. 5, an alternative embodiment of the system 10 illustrating an alternative connection of an alternative bracket 216 is shown. The bracket 216 of FIG. 5 may comprise bracket pins 40 on the bottom portion to allow snapping of the bracket 216 to a mounting plate 42 attached to the board 14, allowing the brackets 216 to be removable from the board 14 when attachment to another board (e.g., 12 in FIG. 1) is not desired.

It should be understood, of course, that the foregoing relates to exemplary embodiments of the invention and that modifications may be made without departing from the spirit and scope of the invention as set forth in the following claims.

We claim:

1. An apparatus, comprising:
a first board;
a second board; and
one or more cross members, each cross member connecting the first board and the second board.

2. The apparatus of claim 1, wherein each cross member has a first end and a second end, wherein the first end is capable of attachment the first board and the second end is attachable to the second board.

3. The apparatus of claim 2, wherein the first end is attachable to a first bracket on the first board and the second end is attachable to a second bracket on the second board.

4. The apparatus of claim 3, wherein each of the first and second brackets allow for rotation of the one or more cross members with respect to the first and second boards.

5. The apparatus of claim 4, wherein the first bracket further comprises a first shaft fit through a first bearing fit within the first end and a second shaft fit through a second bearing fit within the second end.

6. The apparatus of claim 1, wherein each cross member has a length, and wherein the length of each cross member is adjustable.

7. The apparatus of claim 7, wherein each cross member is tubular.

8. The apparatus of claim 8, wherein each cross member comprises an outer tube portion and an inner tube portion, wherein the length the cross member is adjustable by means of sliding the outer tube portion with respect to the inner tube portion.

9. The apparatus of claim 9, wherein each outer tube portion comprises a plurality of adjustment holes for receiving a button lock of the inner tube portion to provide lockability at a desired length.

10. An apparatus, comprising:
a plurality of boards, including a first board and a second board; and
one or more cross members, each cross member having a first end and a second end, the first end connected to a first bracket on the first board and the second end connected to a second bracket on the second board.

11. The apparatus of claim 10, wherein each of the first and second brackets allow for rotation of the one or more cross members with respect to the first and second boards.

12. The apparatus of claim 11, wherein the first bracket further comprises a first shaft fit through a first bearing fit within the first end and a second shaft fit through a second bearing fit within the second end.

13. The apparatus of claim 10, wherein each cross member has a length, and wherein the length of each cross member is adjustable.

14. The apparatus of claim 13, wherein each cross member is tubular.

15. The apparatus of claim 14, wherein each cross member comprises an outer tube portion and an inner tube portion, wherein the length the cross member is adjustable by means of sliding the outer tube portion with respect to the inner tube portion.
